(19) United States
(12) Patent Application Publication
(10) Pub. No.: US 2010/0322396 A1
(43) Pub. Date: Dec. 23, 2010

(54) Telephone Carrier ID

(76) Inventor: Christopher Paul Southerland, North Richland Hills, TX (US)

Correspondence Address: SCOTT L. HARPER, 1700 Pacific Avenue, Suite 3600, DALLAS, TX, 75201, US

(21) Appl. No.: 12/817,947

(22) Filed: Jun. 17, 2010

Related U.S. Application Data
(60) Provisional application No. 61/268,941, filed on Jun. 18, 2009.

(51) Int. Cl. H04M 1/64; H04M 3/42

(52) U.S. Cl. 379/88.19; 379/210.01

(57) ABSTRACT

A method for providing communications network identification data (carrier ID) to a calling party and/or a receiving party in advance of the termination, acceptance or refusal of the call request from a first party to a second party. The highlighted background and/or carrier name and information of the calling and/or receiving party are displayed on the calling party and/or receiving party's endpoint device(s) and may be associated and displayed with their respective caller ID information. Upon display of the carrier ID information, the calling party and/or the receiving party may accept, terminate or decline the call request pursuant to the carrier ID information of each respective party.

### CROSS-REFERENCE TO RELATED APPLICATIONS

Pursuant to 35 U.S.C. §119, this application claims the benefit of and priority to provisional U.S. patent application Ser. No. 61/268,941, filed on Jun. 18, 2009.

### TECHNICAL FIELD

The present invention relates in general to telecommunication services and, more particularly, to providing caller carrier information to call participants over a wired or wireless communications system.

### BACKGROUND OF THE INVENTION

Telephone service providers offer a variety of optional services to their customers. Some of these services provide certain information about a party placing a call (a calling party) to a person or persons receiving a call (a receiving party). One such service is known as caller ID, which provides certain information to the receiving party as to the identity (name or company name) and/or phone number of the calling party. The receiving party may view the caller ID information on the display of their phone, cell phone, PDA, Smartphone or other display prior to answering the call, thereby giving the receiving party the choice to accept the call request from the calling party or not to accept the call request.

Caller ID services are available in almost all forms of currently operating telephone systems and networks, including POTS networks, cellular networks, digital telephone networks, internet telephony, and Voice Over Internet Protocol (VOIP) networks to name a few. Almost all communication and phone devices in circulation today include a display capable of displaying alphanumeric characters, images and other data. Such devices include mobile phones, telephones with an integrated display, Smartphones (e.g. Iphone and Blackberry devices), and other various telephones and communication devices (“communication device” or “endpoint”) as known in the art.

Some telephone service and data providers offer various packages of service to customers. Such plans may offer certain discounts or inducements to consumers whereby reduced rates or “no charge” rates are offered to subscribers who call other subscribers within a particular communication network. For example, certain communication providers offer a “friends and family” plan where call participants are not charged when the calling party and receiving party are both subscribers to the same communications network such as AT&T, Verizon, and Sprint. However, if the calling party and the receiving party subscribe to different networks (e.g. AT&T versus Sprint), then charges may accrue to either or both the calling and receiving party for calls which are made and accepted between the calling party and receiving party. Therefore, the calling and/or receiving party may not wish to initiate or answer a call from a calling party or receiving party who subscribes to a different network so as to avoid costly charges and fees charged by their respective carriers.

As such, there is a need to provide a network or “carrier” identification data service (“carrier ID”) which allows a calling party and/or receiving party to determine the carrier or network from which a call request originates or is transmitted, so as to determine whether or not such call is in the same or a different network as that of the receiving party.

### SUMMARY OF THE INVENTION

In accordance with the present invention, a method for providing carrier network information to either or both a calling party and a receiving party is disclosed. In one embodiment, a calling party initiates a call to a receiving party. After initiating the call, a database is queried and the receiving party's carrier data is retrieved and displayed on the calling party's communication device. Next, the calling party's carrier data is retrieved and displayed on the receiving party's communication device.

If the transmitted carrier network data identifies both the calling party and the receiving party as subscribers on the same communications network, the receiving party may elect to answer the call from the calling party. If the carrier data identifies that the calling party and receiving party subscribe to different communications networks, the receiving party may elect to decline the call request from the calling party in order to prevent the accrual of out of network charges by either or both communications network providers.

In one embodiment of the invention disclosed herein, another feature of the disclosed method allows the calling party to designate or associate the carrier ID with a party's caller ID information. The associated caller ID/carrier ID information is transmitted to either or both party's communication device prior to the acceptance of the call request by a party.

In one embodiment of the invention disclosed herein, a method for displaying a highlighted background and/or carrier name is associated with a caller ID identifier. An image is associated with a particular caller ID identifier and stored on a storage medium. When an incoming call signal identifier is received by the receiving party's phone or other endpoint device, the communications device or external database determines whether the incoming call signal identifier is a match with the predetermined caller ID identifier, which allows the receiving party to selectively answer the incoming call in response to the displayed caller ID information and network carrier identification.

Accordingly, the invention disclosed herein provides several advantages including an improved carrier ID, the ability to provide the calling party and/or receiving party with the carrier information associated with a calling party and receiving party for determining if the call will be “in” network or “out” of network, thereby resulting in no service charges or the accrual of service charges, respectively.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a network diagram showing an operating environment of the present invention in accordance with the invention disclosed herein;

FIG. 2 is a diagram illustrating an endpoint displaying network information in accordance with the invention disclosed herein;

FIGS. 3A-3C are diagrams of various communication endpoints illustrating various network identification data in accordance with the invention disclosed herein;

FIG. 4 is a flow diagram showing the implementation of a network carrier identification method in accordance with the invention disclosed herein; and,

FIG. 5 is a flow diagram depicting an alternative implementation of a network carrier identification method in accordance with the present invention disclosed herein.

### DETAILED DESCRIPTION OF THE INVENTION

For purposes of teaching and discussion, it is useful to provide some overview as to the way in which the invention disclosed herein operates. The following information may be viewed as a basis from which the present invention may by properly explained. Such information is offered for purposes of explanation only and, accordingly, should not be construed to limit the broad scope of the present invention and its potential applications.

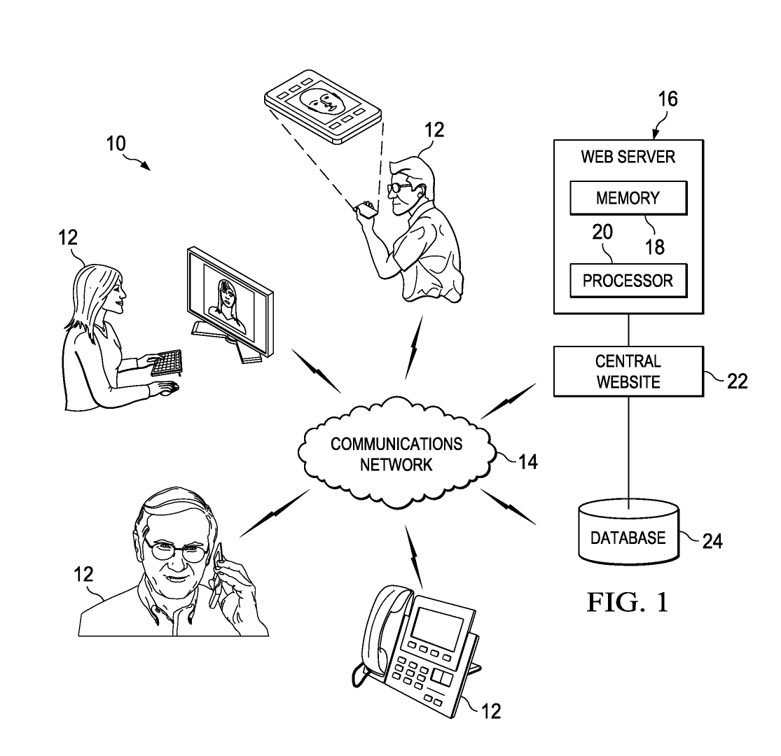

FIG. 1 is a simplified diagram of a communication system 10 for communicating, receiving, and transmitting telephone calls and data in a communications network 14. Communications network 14 may consist of or be implemented through a plain old telephone system (POTS) network, public switched telephone network (PSTN), Advanced Intelligent Network (AIN), VOIP network, digital and/or cellular networks, and internet communications data networks as known to those of skill in the art. Communication system 10 includes endpoints 12, communications network 14, web server 16 including memory 18 and processor 20, a central website 22, and database 24. Endpoints are communication devices which are utilized by users or customers to initiate a communication session in communication system 10 via network 14. In one example implementation, endpoint devices 12 are Smartphones, such as a Blackberry or Iphone, that are operable to interface with communications network 14 for the purposes of initiating, conducting and terminating a communication session between the users. Note also that the term ‘endpoint’ may be inclusive of devices which include processors, memory and displays among other components and which are used to initiate, conduct and terminate a communications or data session between users, such as a computer, a personal digital assistant (PDA), a laptop or electronic notebook, a telephone, a cellular telephone, an IP telephone, an Iphone, or any other device, component, element, or object capable of initiating voice, audio, or data exchanges within communication system 10 as known in the art. Endpoints 12 may also be inclusive of a suitable interface to the human user, such as a microphone, a display, or a keyboard or other terminal equipment. Endpoints 12 may also be any device that seeks to initiate a communication session on behalf of another entity or element, such as a program, a database, or any other component, device, element, or object capable of initiating a voice or a data exchange within communication system 10. Data, as used herein in this document, refers to any type of numeric, voice, or script data, or any type of source or object code, or any other suitable information in any appropriate format that may be communicated from one endpoint 12 to another over network 14.

Any device capable of operating as an endpoint 12 may connect to communications network 14 via wire, wireless, cellular, satellite link or other suitable interfaces as is known to those of skill in the art. Web server 16, which includes memory 18 and processor 20, hosts central website 22 and has access to transmit and receive end user or presence data, such as user profile data, end user and/or user endpoint data, user contact data, user address and telephone numbers, user communications network data, and/or carrier or network identification data from database 24. Presence data may be collected, aggregated, and utilized and/or displayed to the user by one or several endpoints 12 to facilitate user or network decisions related to communications between endpoints 12 over communications network 14.

Central website 22 can be configured to interface with endpoints 12 and database 24, and may display data inputs from users via endpoints 12 and/or database 24. In one embodiment, the carrier identification for one or more communications networks is input and stored on database 24. In one example, software that resides in web server 16 (which may be included within central website 22 is executed by processor 20 (potentially in conjunction with memory 18) to achieve the communication coordination between two or more endpoints 12. Such activity could also be developed externally and then uploaded to web server 16 via central website 22.

Central website 22 and/or web server 16 may include software and/or algorithms to achieve the operations for processing, storing, communicating, delivering, gathering, uploading, maintaining, and/or generally managing data and communications traffic and presence data as described herein. Alternatively, such operations and techniques may be achieved by any suitable hardware, component, device, application specific integrated circuit (ASIC), additional software, server, processor, algorithm, erasable programmable ROM (EPROM), electrically erasable programmable ROM (EEPROM), or any other suitable object or network that is operable to facilitate such operations. Considerable flexibility is provided by the structure of central website 22 and web server 16 in the context of system 10. Thus, it can be easily appreciated that such functions could be provided external to central website 22 and web server 16 (e.g. as a solitary and/or proprietary database or other component). In such cases, such functionality could be readily embodied in a separate component, server, processor, device, or module. Note that these data coordination features and capabilities may be provided in the described elements or distributed across the network architectures previously described herein and as are known to those of skill in the art.

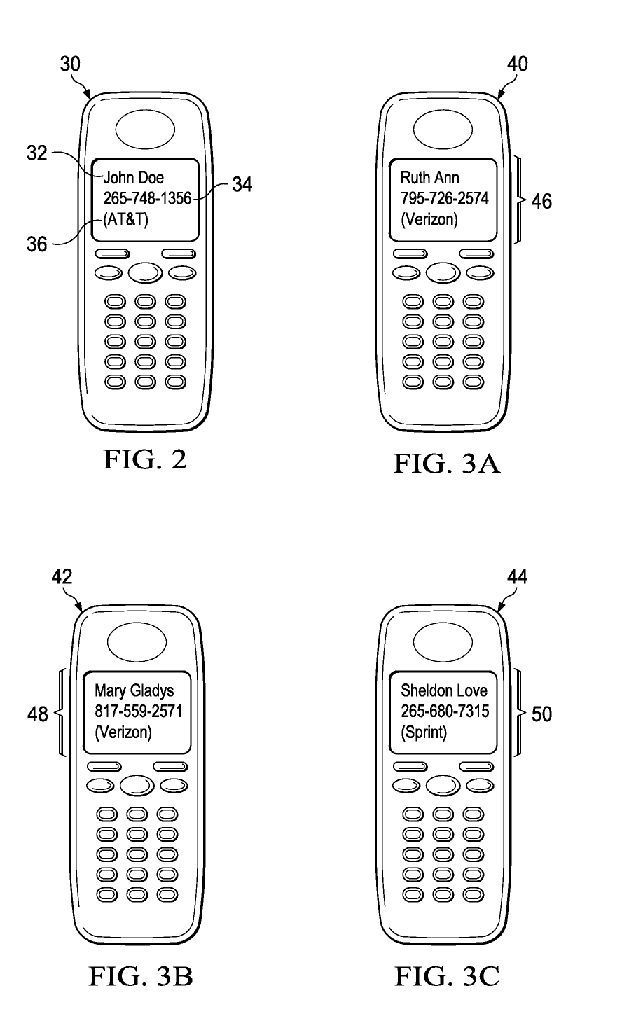

FIG. 2 shows a typical telephone 30 with a display window. On the display window, presence data consisting of caller ID and carrier ID data is shown. The caller ID name and telephone number data 32,34 consists of the name 32 and telephone number 34 of the calling party. The carrier ID data 36 is also shown indicating that the communications network carrier of the calling party which is transmitting the call request to the receiving party is AT&T in this example. In one embodiment, the carrier ID data 36 may be highlighted in various colors as selected by the user input by the user via website 22 and stored on database 24. In still another embodiment, presence data which includes caller ID and carrier ID information 32,34,36 may be stored locally in the memory of the endpoint device 12.

FIGS. 3A-3C show multiple endpoints displaying caller ID data and carrier ID data in a telephone call request originating from endpoint 40 shown in FIG. 3A to endpoint 42 shown in FIG. 3B via communications system 10 and/or endpoint 44 depicted in FIG. 3C. For example, Mary Gladys accesses her cell phone 40 and inputs Ruth Ann's phone number. Prior to the initiation of the call signal to Ruth Ann's phone 42, the caller ID and/or carrier ID information pertaining to Ruth Ann's phone (her name, phone number, and carrier) 46 is displayed on Mary Gladys' cell phone 40. As such, prior to initiation of the call request, Mary Gladys may determine whether Ruth Ann is a subscriber to the same network as Mary Gladys and determine whether or not to initiate the call request to Ruth Ann's phone 42. In this example, Mary Gladys' phone displays information 46 indicating that Ruth Ann is a Verizon network subscriber. If Mary Gladys' carrier is not Verizon, then Mary Gladys may decide not to transmit a call signal (e.g. push the “dial” button) to Ruth Ann's phone so as to avoid out of network charges and fees. However, if Mary Gladys' carrier is Verizon she may decide to proceed with the call request and a call request signal is transmitted to Ruth Ann's phone 42. The caller ID and/or carrier ID information 48 associated with Mary Gladys' phone 40 is displayed on Ruth Ann's phone 42. As such, Ruth Ann has the option of accepting the call from Mary Gladys or declining the call from Mary Gladys in view of the caller ID and/or carrier ID information indicating whether or not Mary Gladys is a member of the same network as Ruth Ann.

In an alternative embodiment and using the general method described above, the method and system disclosed herein may accommodate multiple callers or conference calls among two or more parties. For example, assuming that Ruth Ann and Mary Gladys are enjoying a phone conversation using their respective endpoint devices 40, 42 and now they wish to call Sheldon Love. Mary Gladys keys in Sheldon Love's phone number or may access his contact information stored on her phone and prior to the initiation of the call signal from Mary Gladys' phone 40 to Sheldon Love's phone 44, the caller ID and/or carrier ID information pertaining to Sheldon Love's phone (his name, phone number, and carrier ID) 50 is displayed on Mary Gladys' cell phone 40. As such, prior to initiation of the call request, Mary Gladys may determine whether Sheldon Love is a subscriber to the same network as Mary Gladys and determine whether or not to initiate the call request to Ruth Ann's phone 42. In this example, Mary Gladys' phone 40 would display the information 50 indicating that Sheldon Love is a Sprint network subscriber. If Mary Gladys' carrier is not Sprint, then Mary Gladys may decide not to transmit a call signal (e.g. push the “dial” button) to Sheldon Love's phone so as to avoid out of network charges and fees. However, if Mary Gladys decides to proceed with the call request, a call request signal is transmitted to Sheldon Love's phone 44. The caller ID and/or carrier ID information 48 associated with Mary Gladys' phone 40 would then be displayed on Sheldon Love's phone 44. As such, Sheldon Love has the option of accepting the call from Mary Gladys or declining the call from Mary Gladys in view of the caller ID and/or carrier ID information displayed on Sheldon Love's phone 44.

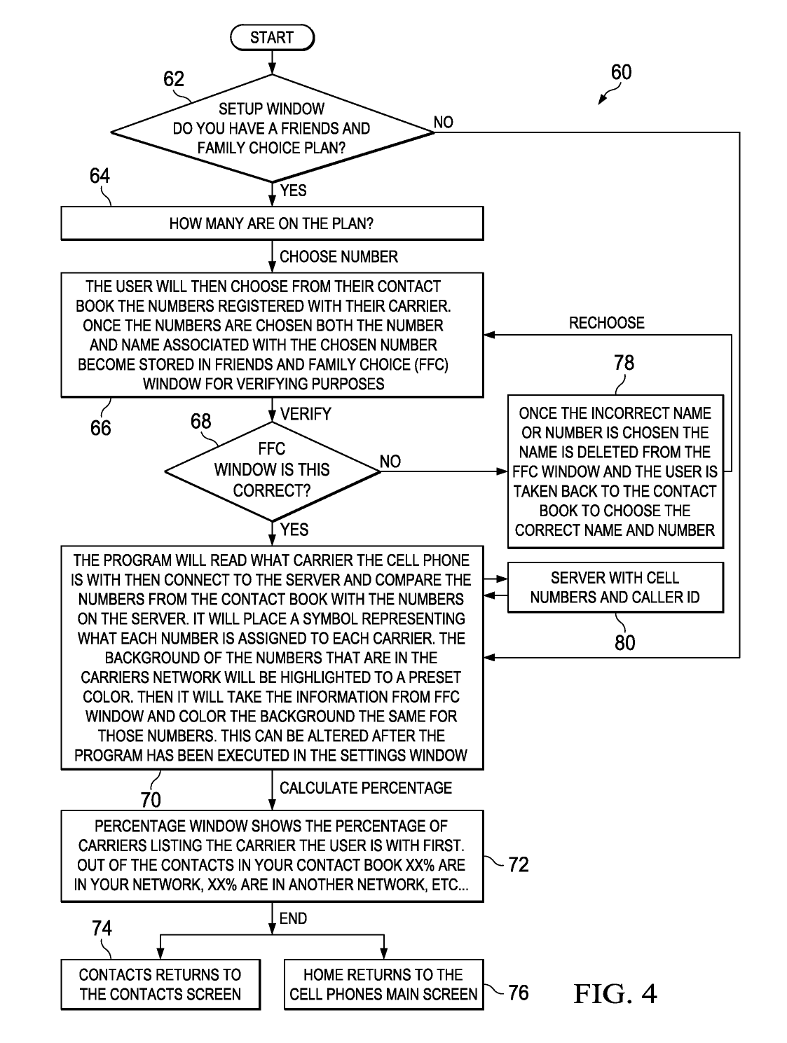

FIG. 4 is a flow diagram illustrating a series of steps for inputting and associating information and data related to the caller ID and carrier ID information discussed herein. Such information and data may be input and stored within a memory module located on the user's endpoint device or on a network database or server. In the depicted embodiment, the user decides to associate an endpoint device and enters information pertaining to his or her carrier network offerings or “plan.” The user is asked to input whether or not they have a “friends and family” plan (Step 62). For example, certain communications network offerings typically provide that relatives or other friends who have devices or endpoints using or subscribing to the same or mutual carrier network as the user are entitled to reduced per minute call charges, or no per minute charges, when calls are made between endpoints located on the same carrier network. In this example, the user inputs that they are a member of a mutual network (Step 62), inputs the number of contacts on the mutual network (Step 64) and provides the telephone numbers of their mutual contacts registered with the carrier (Step 68). The user is then asked to verify the carrier plan type and information which was previously input (Step 68). If the user elects to proceed, the method notes the user's network information and accesses a server or database to compare the user's contact book information (name and telephone number or “caller ID” information) with the name and/or telephone number and/or carrier data information residing on the server or database (Step 80), associates the caller ID information with the carrier ID data, and presents the associated caller ID and carrier ID information on the user's endpoint display (Step 70). The carrier ID information may be highlighted or presented with various visual cues for the ease of the user. If the user inputs incorrect information at (Step 66) and answers that the input data is incorrect at (Step 68), the incorrect name or telephone information is deleted and the user is asked to input the correct information (Step 66). After the caller ID and carrier ID information is associated (Step 70), the method calculates the percentage of carriers associated with contacts input by the user and presents this data to the user (Step 72). For example, the user will be shown that 25% of her contacts are subscribers to AT&T, 50% are Verizon subscribers, 15% are Nextel subscribers and 10% are subscribed to “Other” networks (e.g. local or regional cell phone service providers). The user may then elect to proceed to the contacts screen for entry or editing of the contacts list (Step 74) or exit to the endpoints main or “home” screen (Step 76). In the event a user is not a subscriber to a “friends and family plan” or other type of carrier discount plan, the method will move to (Step 70) and proceed as described and shown herein.

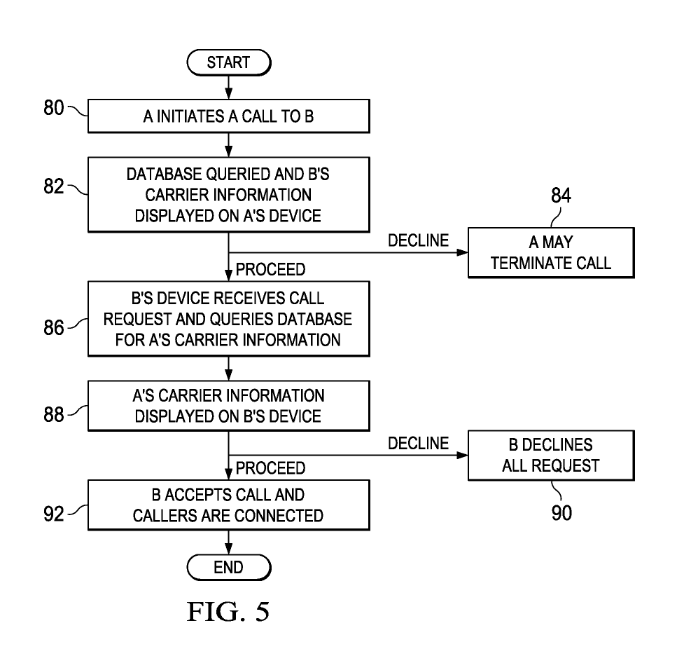

FIG. 5 is a process diagram illustrating an embodiment of the carrier ID method described herein. In this example, A desires to initiate a phone conversation with B. A initiates a call to B by entering B's phone number which is associated with B's endpoint device (Step 80). After initiating the call and prior to the call request being transmitted to B's endpoint device, a database is queried in response to A's call request which associates B's caller ID information with B's carrier ID information and B's carrier information is displayed to A on A's endpoint device (Step 82). If A determines from B's carrier ID that B is not a subscriber on the same network, A may choose to terminate the call request to B to avoid network provider charges (Step 84). Alternatively, if A determines from B's carrier ID information that B is a subscriber to the same network as A, or alternatively, B is a member of A's “friends and family” plan, then A may elect to proceed with transmitting the call request which results in B's endpoint device querying a database in response to the call request from A for the caller ID and/or carrier ID associated with A's endpoint device (Step 86). If B determines from A's carrier ID that A is not a subscriber on the same network, B may choose to decline the call request from A to avoid network provider charges (Step 90). Alternatively, if B determines from A's carrier ID information that A is a subscriber to the same network as B, or alternatively, A is a member of B's “friends and family” plan, then B may elect to accept the call request from A resulting in the call being connected between A and B until the call is completed (Step 92).

In various contemplated alternative embodiments, the carrier ID information associated with a particular endpoint or user may be stored as an image either locally on the endpoint or on a network server or database as is commonly used and known in the art. Such image files may be easily transmitted, received and displayed by endpoint devices over the networks described herein. Likewise, in contemplated alternative embodiments, more than two callers or endpoints may initiate and either terminate or refuse call requests from multiple endpoints using the method and system disclosed herein and the examples and descriptions set forth herein are not to be construed as limited to only two endpoints or users.

The present embodiments may be implemented with communication systems, networks, software and logic as known to those of skill in the art. It is intended that the foregoing detailed description be understood as an illustration of selected forms that the invention can take and not as a definition of the invention. It is only the claims, including all equivalents, which are intended to define the scope of the invention disclosed herein.

What is claimed is:

1. A method, comprising:
initiating a call from a first endpoint to a second endpoint;
associating at least one endpoint with presence data;
displaying the presence data associated with the second endpoint on the first endpoint prior to the acceptance, termination or refusal of the call request.

2. The method of claim 1, further comprising:
sending the presence data associated with the first endpoint to the second endpoint.

3. The method of claim 1, further comprising:
displaying the presence data associated with the first endpoint on the second endpoint prior to the acceptance or refusal of the call request.

4. The method of claim 1 wherein the first endpoint terminates the call request to the second endpoint prior to connection of the call between the first endpoint and the second endpoint.

5. The method of claim 1 wherein the presence data associated with a caller ID of at least one endpoint is input to a database via a website.

6. The method of claim 1 wherein the presence data is stored locally on at least one endpoint as an image.

7. The method of claim 1 wherein the first endpoint and second endpoint comprise one of a Smartphone, Iphone, cell phone, a personal digital assistant, a television, a display, a computer, a laptop computer or telephone coupled with display.

8. The method of claim 1 wherein the presence data consists of carrier ID data.

9. A method, comprising:
initiating a call from a first endpoint to a second endpoint;
associating at least one endpoint with a carrier ID;
querying a database for the carrier ID associated with the second endpoint in response to the initiation of a call request from the first endpoint;
sending the carrier ID associated with the second endpoint to the first endpoint; and,
displaying the carrier ID associated with the second endpoint on the first endpoint prior to the acceptance or refusal of the call request.

10. The method of claim 9 wherein the carrier ID data associated with at least one endpoint is input to a database via a website.

11. The method of claim 9 wherein the carrier ID data associated with at least one endpoint is stored locally on at least one endpoint.

12. The method of claim 9 wherein the carrier ID data associated with at least one endpoint is stored on a network database.

13. The method of claim 9 wherein the carrier ID includes network carrier information.

14. The method of claim 9 wherein a substantial portion of the contact data stored locally on at least one endpoint is associated with carrier ID information.

15. A method, comprising:
initiating a call from a first endpoint to a second endpoint over a communications network;
associating at least one endpoint with a carrier ID;
querying a database for the carrier ID associated with the second endpoint in response to the initiation of a call request from the first endpoint;
sending the carrier ID associated with the second endpoint to the first endpoint;
displaying the carrier ID associated with the second endpoint on the first endpoint prior to the acceptance or termination of the call request;
querying the database for the carrier ID associated with the first endpoint in response to the call request received from the first endpoint by the second endpoint;
sending the carrier ID associated with the first endpoint to the second endpoint; and,
displaying the carrier ID associated with the first endpoint on the second endpoint prior to acceptance or termination of the call request.

16. The method of claim 15 wherein the first endpoint terminates the call request from the first endpoint prior to acceptance of the call request transmitted to the second endpoint.

17. The method of claim 15 wherein the second endpoint declines the call request received from the first endpoint after viewing the carrier ID information associated with the first endpoint.

18. The method of claim 15 wherein the second endpoint accepts the call request from the first endpoint after viewing the carrier ID information associated with the first endpoint.

19. The method of claim 15 wherein the first endpoint transmits the call request to the second endpoint after the carrier id information associated with the second endpoint has been displayed on the first endpoint.

20. The method of claim 15 wherein the second endpoint only accepts the call request from the first endpoint after the carrier ID associated with the first endpoint has been displayed on the second endpoint.

21. The method of claim 15 wherein the call request from the first endpoint is transmitted to the second endpoint only if the first endpoint and second endpoint have identical carrier ID.

22. The method of claim 15 wherein the carrier ID data is stored as an image.
